(19) United States
(12) Patent Application Publication
(10) Pub. No.: US 2003/0219121 A1
(43) Pub. Date: Nov. 27, 2003

(54) Biometric key generation for secure storage

(75) Inventor: Nicholas Benedict van Someren, Cambridge (GB)

Correspondence Address: Michael J. Bevilacqua, Hale and Dorr LLP, 60 State Street, Boston, MA, 02109, US

(73) Assignee: nCipher Corporation, Ltd, Cambridge (GB)

(21) Appl. No.: 10/155,594

(22) Filed: May 24, 2002

(51) Int. Cl. H04L 9/00

(52) U.S. Cl. 380/44; 713/186

(57) ABSTRACT

A method and apparatus for the generation and use of a biometric cryptographic key to secure and retrieve data that involves combining a random key and the biometric information to generate a template, such that the cryptographic key needed to retrieve the data cannot be obtained from the combination unless the identical user submits his or her biometric information during a subsequent biometric scan at which time the cryptographic key is generated from a combination of the stored template and the scan, allowing the secured data to be released and/or decrypted. Thus, if the system containing the secured data were compromised it would be virtually impossible to decrypt the data because not enough information resides on the system to re-construct the cryptographic key.

### FIELD OF THE INVENTION

The present invention relates to cryptographic keys derived from biometric information for use in securely storing data and more specifically, to the generation and use of a cryptographic biometric key that cannot be derived from information stored with the secured data.

### BACKGROUND OF THE INVENTION

As society increases its reliance on digital storage for vital information, the need to control who has access to such information becomes more critical. Numerous systems currently exist that control who can and cannot access information. An example of such a system is an ATM machine, in which an account holder accesses his or her information using, in combination, a magnetically encoded card and a personal identification number (PIN). In cases where the information is particularly sensitive, such as for the national defense, other means of securing and controlling information involve mechanically or optically scanning, or otherwise sampling, a unique aspect of a user's physiology. Examples of such aspects include a user's voice, fingerprint, face, iris, or retina. Typically, such systems operate by performing a scan of the physiological characteristic of the user and, from this scan, creating a template of the biometric information which is stored in memory on the same machine on which the data is stored. For an additional layer of security the data may be encrypted using the cryptographic key to encrypt and decrypt the stored data. The biometric information in such systems is used to decide whether the user can use the cryptographic key. Once the user is authenticated, he or she may then access the information that they have been designated to access, using the cryptographic key to release and, if applicable, decrypt the data.

The process for performing the scan of the physiological characteristic of the user is generally referred to as a registration phase. Referring to FIG. 1(a), in the registration phase of existing systems that control access to data using biometrics, some aspect of the user 10 is scanned by a biometric scanner 12. The output of the scanner is then presented to a security device 14 along with the data to be secured 16. The scan of the user is secured inside the secure device 14 in a template 18 and the data to be secured is stored in a data storage device 20.

As shown in FIG. 1(b), when the data is to be retrieved, the user 10 is scanned again by the biometric scanner 12 and the output of the scan is compared to the value stored in the template 18 by a comparison device 22. The nature of biometric scan, prevents the comparison from being exact and the comparison device 22 must allow for differences between the new scan and the stored template 20 up to some threshold error level. If the new scan is close enough to the template, the access control system 24 allows the data in the data store 22 to be accessed.

In existing systems that use biometric information to control access to data, the biometric template and the encrypted data are typically stored on the same device, such as the secure device 14 shown in FIGS. 1(a) and 1(b). Data, encrypted or otherwise, in such a system is vulnerable to attacks from unauthorized users. If the system containing the data and biometric template is compromised, access could be gained to the biometric templates, and the templates could then be used to obtain access to the secured data whether or not it is encrypted.

It is therefore a principal object of the present invention to provide a truly secure system for storing and retrieving data in which the cryptographic key is stored separately from the secured data.

It is a further object of the present invention to provide a secure system for storing and retrieving data in which the cryptographic key is derived from a biometric scan.

### SUMMARY OF THE INVENTION

The present invention provides an apparatus and method for the generation and use of a random cryptographic key derived from a user's biometric information to secure and retrieve data using such random cryptographic key. At the time the data is stored a template is generated from the random cryptographic key and a biometric scan of the user and the random cryptographic key is used to encrypt the data. When retrieving the secured data, the random cryptographic key is regenerated from the stored template when the identical user submits his or her biometric information during a subsequent biometric scan thereby allowing the secured data to be accessed, and decrypted, if appropriate. Thus, if the system containing the secured data were compromised it would be virtually impossible to access or decrypt the data because not enough information resides on the system to re-construct the cryptographic random key.

These and other features and functions of the present invention will be more fully understood from the following detailed description which shall be read in light of the accompanying drawings.

### BRIEF DESCRIPTION OF THE DRAWINGS

FIG. 1(a) is a block diagram of the registration phase of a prior art secure storage system.

FIG. 1(b) is a block diagram of the retrieval phase of a prior art secure storage system.

FIG. 2(a) is a block diagram of the registration phase of the secure storage system of the present invention.

FIG. 2(b) is a block diagram of the retrieval phase of the secure storage system shown in FIG. 2(a).

FIG. 3(a) is a block diagram of the registration phase of an alternate embodiment of the secure storage system of the present invention.

FIG. 3(b) is a block diagram of the retrieval phase of the secure storage system shown in FIG. 3(a).

FIG. 4 is a flow chart illustrating the registration stage of the method of the present invention.

FIG. 5 is a flow chart of retrieval stage of the method shown in FIG. 4.

FIG. 6 is a flow chart of the registration stage of an alternate embodiment of the present invention.

FIG. 7 is a flow chart of the retrieval stage of the alternate embodiment of the present invention shown in FIG. 6.

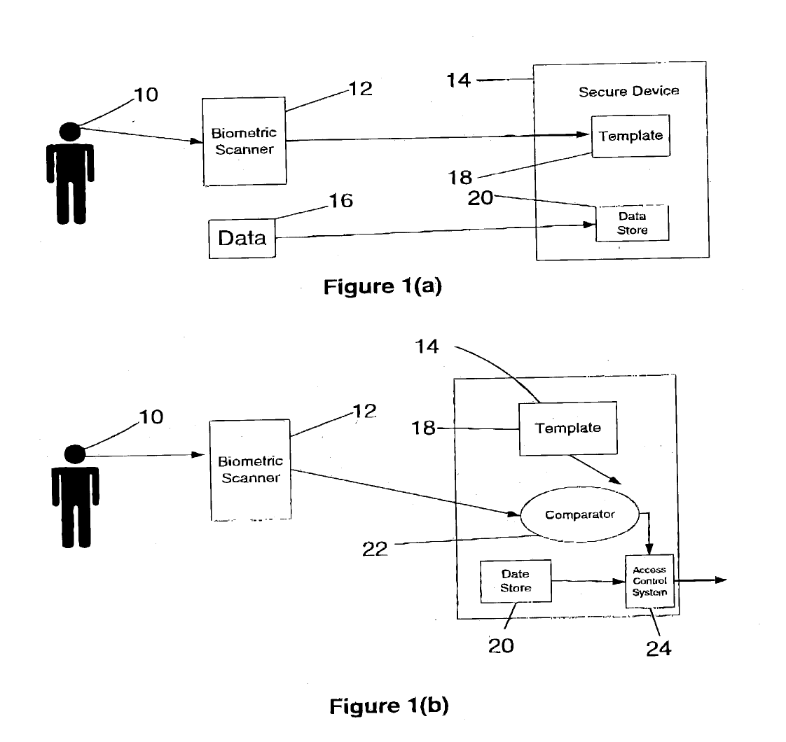

### DETAILED DESCRIPTION OF THE PREFERRED EMBODIMENTS

The present invention is a method and apparatus for the generation and use of a template derived from a user's biometric information and a random cryptographic key to secure and retrieve data, such that the random cryptographic key cannot be obtained to retrieve the data unless the identical user submits his or her biometric information during a subsequent biometric scan at which time the random cryptographic key is regenerated, allowing the secured data to be accessed and, if appropriate, decrypted.

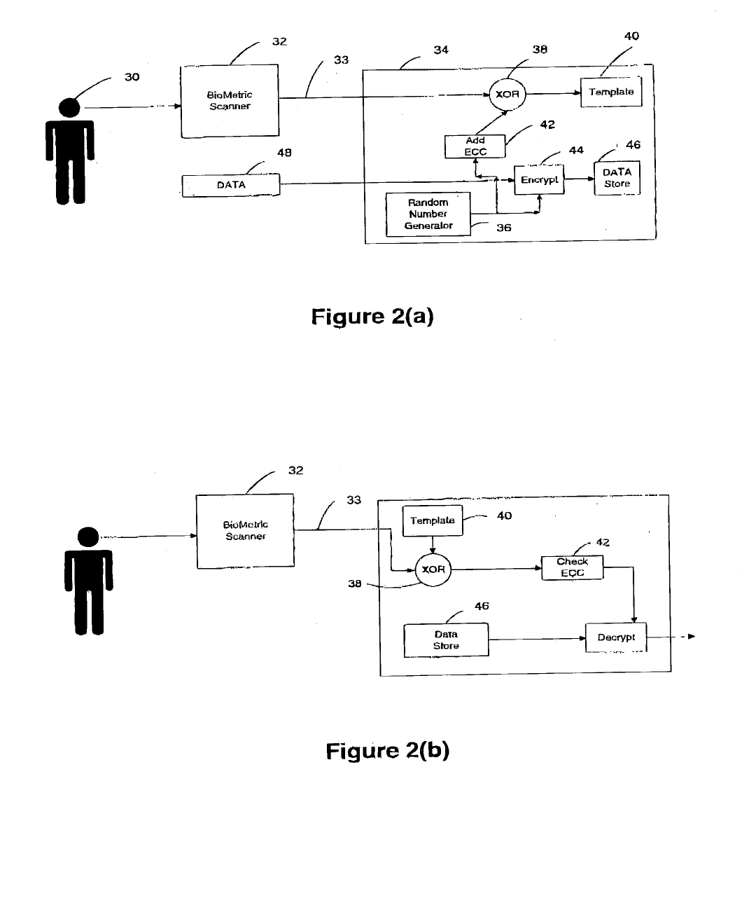

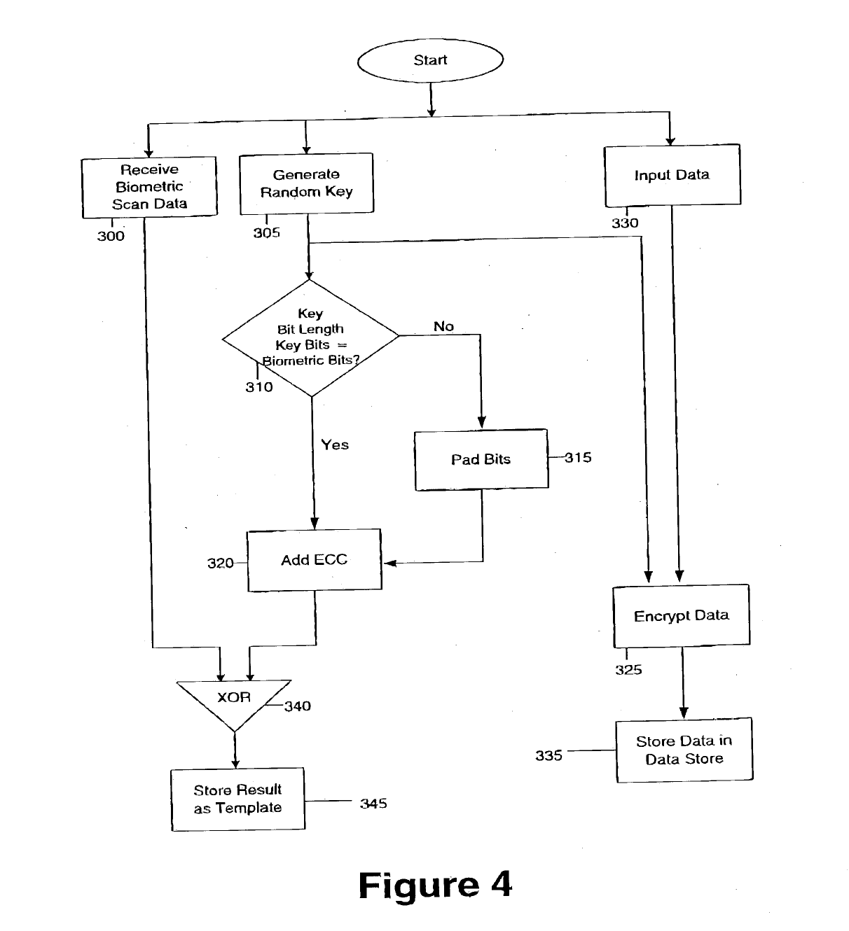

Referring to FIGS. 2a and 4, in the registration stage, a biometric scanning device 32 scans some physiological aspect of a user 30, such as the user's fingerprint, iris, face, retina or voice to generate biometric scan data. In the preferred embodiment, an iris scan is used, but other biometric scanning techniques will be equally effective provided that the matching parameter used by such biometric scanning device 32 is the hamming distance between the processed scan and the template. Suitable iris scanning devices 32 can be obtained from Iriscan Inc. of Marlton, N.J. The biometric scan data is processed by the biometric scanning device 32 and the biometric scan data is provided to secure system 34 in step 300. At about the same time the biometric information is received, a random number generator 36 in the secure system 34 generates a random cryptographic key in step 305. In the preferred embodiment the random number generator 36 is a hardware random number generator, generally referred to as a True Random Number Generator. In step 310, the bit length of the random cryptographic key and the bit length of the biometric scan data are fetched by the biometric scanner 32. If the random cryptographic key is not the same length as the biometric scan data, the random cryptographic key is padded in step 315 and in step 320, an error correction code 42 (“ECC”) is added, so that the combination of the random cryptographic key, the padding and the error correction code has a bit length equal to the bit length of biometric scan data. The ECC is proportional to the length of the data being corrected and in a preferred embodiment the bits added for padding are random valves.

The error correction code is chosen with certain specific properties. In particular, the error correction code must be able to detect and correct exactly the same number of erroneous bits as a threshold hamming distance used by the biometric scanner 32. (The hamming distance between two data streams is the number of corresponding bits in the two streams that are different). The hamming distance is dependent on the exact biometric scheme chosen, the level of certainty that the system is looking at the right user (“the false accept rate”) and the tolerance for refusing access to users own data (“the false reject rate”). The shorter the hamming distance the lower the false accept rate and the higher the false reject rate. For the iris scan system used in a preferred embodiment of the present invention, a distance of about 30% of the number of bits being compared is the preferred distance, but obviously other hamming distances can be used as well. The ECC is chosen based on the desired threshold. The error correction software can be used to work with any biometric scheme. Any commonly used class of error correction codes can be used. One suitable type are the Reed-Solomon codes. An error correction code is required because biometric scanning processes generally cannot maintain perfect fidelity between successive scans. The error correction code allows the variability between successive biometric scans to be accounted for and to ensure that if the user is the correct user, the similarity of the two biometric scans will be within a predetermined threshold, and as such, be able to regenerate the correct cryptographic key.

The random cryptographic key, padding and error correction code are combined with the biometric scan data using a reversible operation 38 such as an exclusive OR operation in step 340. The result of the operation 38 is then stored as a template 40 for future use. The data 48 is input to the secure system 34 in step 330 and it is secured and generally encrypted using the random number generated by random number generator 36. The random value is used as the key and the data to be protected is presented to the encryption function as the data. Any “symmetric” cipher can be used as the encryption function and the US Data Encryption Standard which is a triple key mode (3-DES, NIST FIPS 46-3) or the forthcoming US advanced encryption standard (AES, NIST, no FIPS number as it is still in draft form) could be used. The encrypted data is stored in a data storage device 46 in step 335.

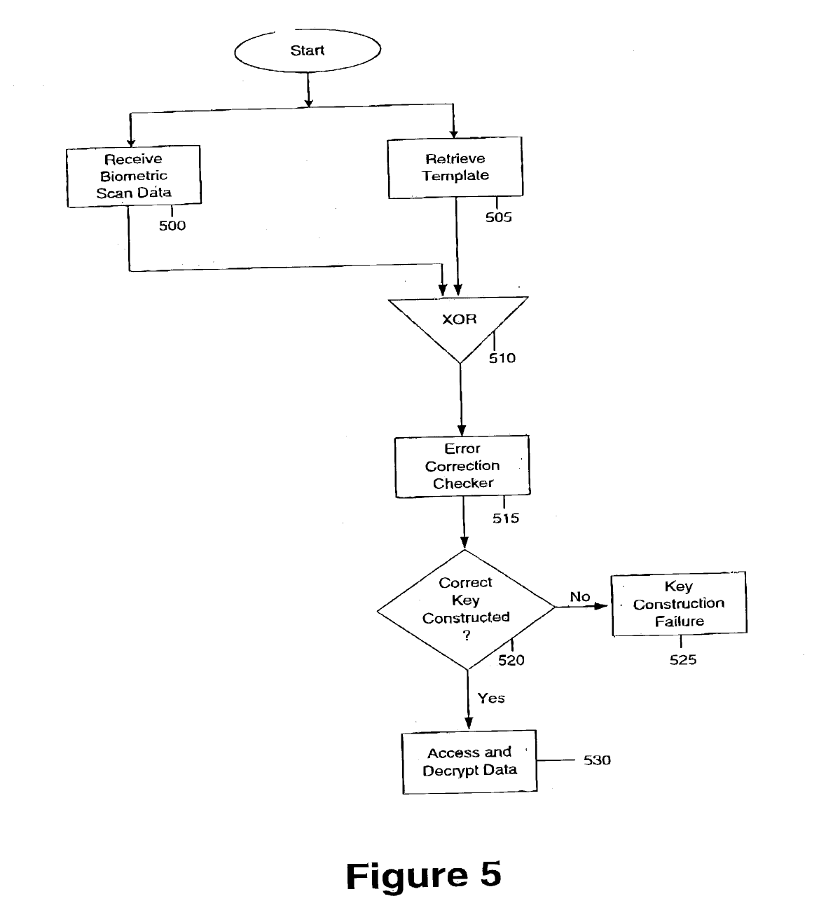

Referring to FIGS. 2(b) and 5, the method for retrieving the secured data will now be described. When the user 30 wants to retrieve secured data, the same physiological aspect that the user used to secure the data is scanned in step 500 by the biometric scanner 32. In step 505, the template 40 is retrieved.

In step 510, the template 40 and biometric scan data are processed by the same reversible operation 38 that was used to secure the data (i.e., in the preferred embodiment, an exclusive OR operation). The result of the reversible operation 38 is passed through the error correction code checker, in step 515. The user is determined in step 520 to be the same person who created the key if the hamming distance between the original scan and the current scan is less than a predetermined threshold. If the user is a different user or an unauthorized user then the difference will be too large to correct and the ECC checker will fail to deliver the correct random cryptographic key and a key construction failure will be generated in step 525. If the user is the correct user, in step 530 the data can be accessed and the correct random cryptographic key is generated to decrypt, the data in the database.

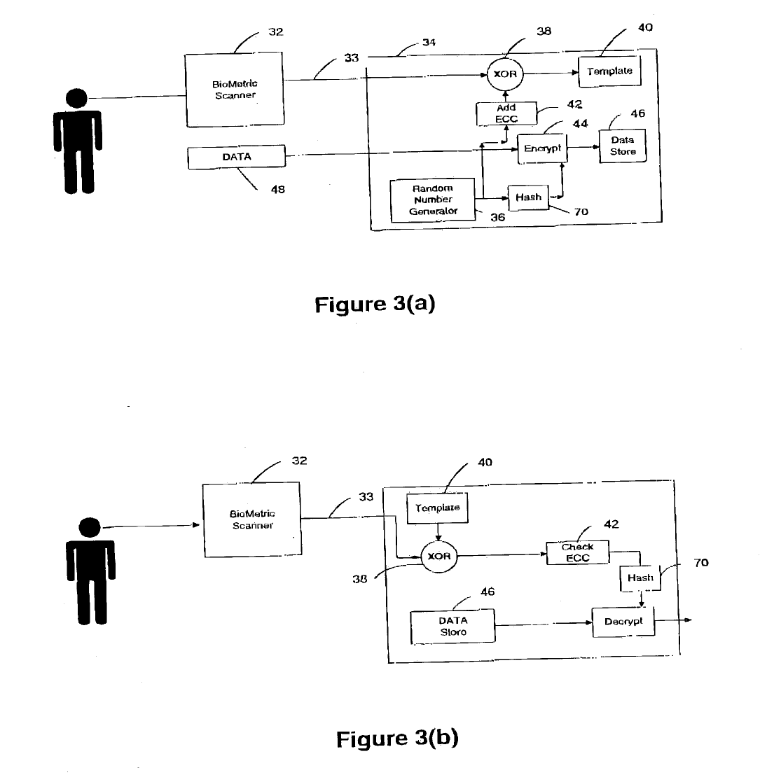

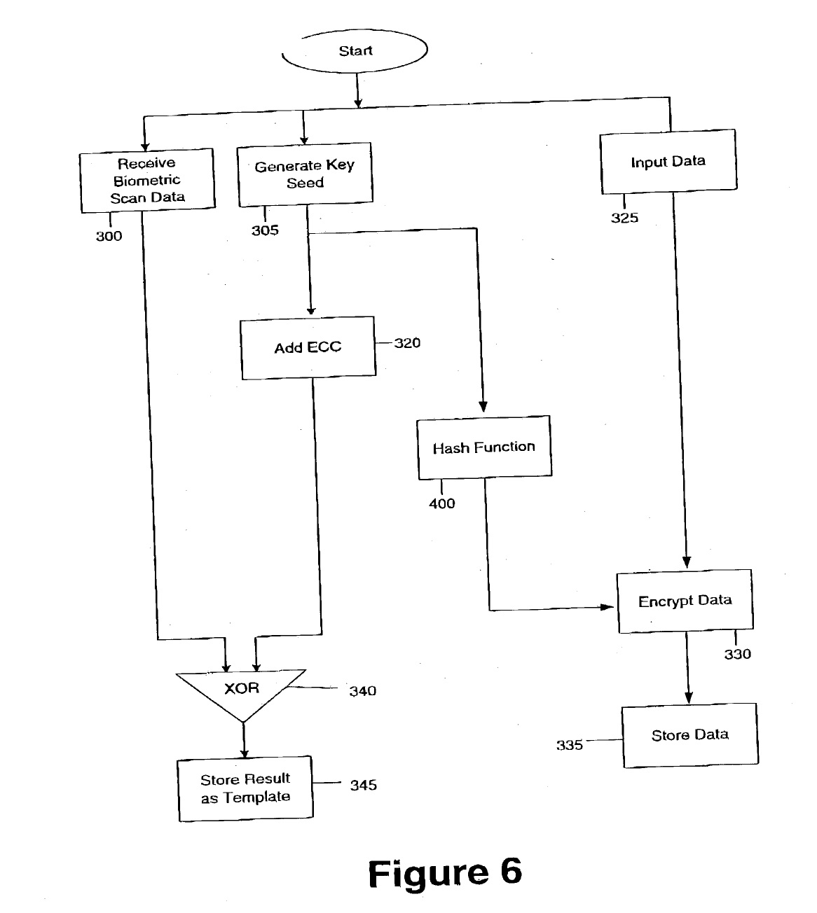

Referring to FIGS. 3(a) and 6, an alternate embodiment of the present invention is shown in which the random cryptographic key is not used directly to secure, encrypt and decrypt the data, but instead is passed through a hash function and the result is then used to secure, encrypt and decrypt the data. In this embodiment, during the registration stage the biometric scanner 32 scans some physiological characteristic of the user 30. The scanned biometric data 33 is received by the system in step 300. At or about the same time the biometric data 33 is received, a random number generator generates, in step 305, a random number 36. The bit length of the random number 36 when combined with the error correction code 42 is equal to the bit length of the biometric scan data. The error correction code 42 is selected using the criteria describe above with respect to the embodiment shown in FIG. 2(a). The random number 36 is then passed through a hash function 70 to create the random cryptographic key that is used in step 330 to secure and/or encrypt data 44 that was input by the user, in step 325. In a preferred embodiment, the hash function used is an implementation of the US Secure Hash Standard (SHS, NIST FIPS-180). Other strong cryptographic hash functions can also be used. The encrypted data is then stored in a data store 46 in step 335. The cryptographic key is also combined with the user's biometric information by a reversible operation 38 (such as an exclusive OR operation) in step 340. The result is then stored as a template 40 for future use in step 345.

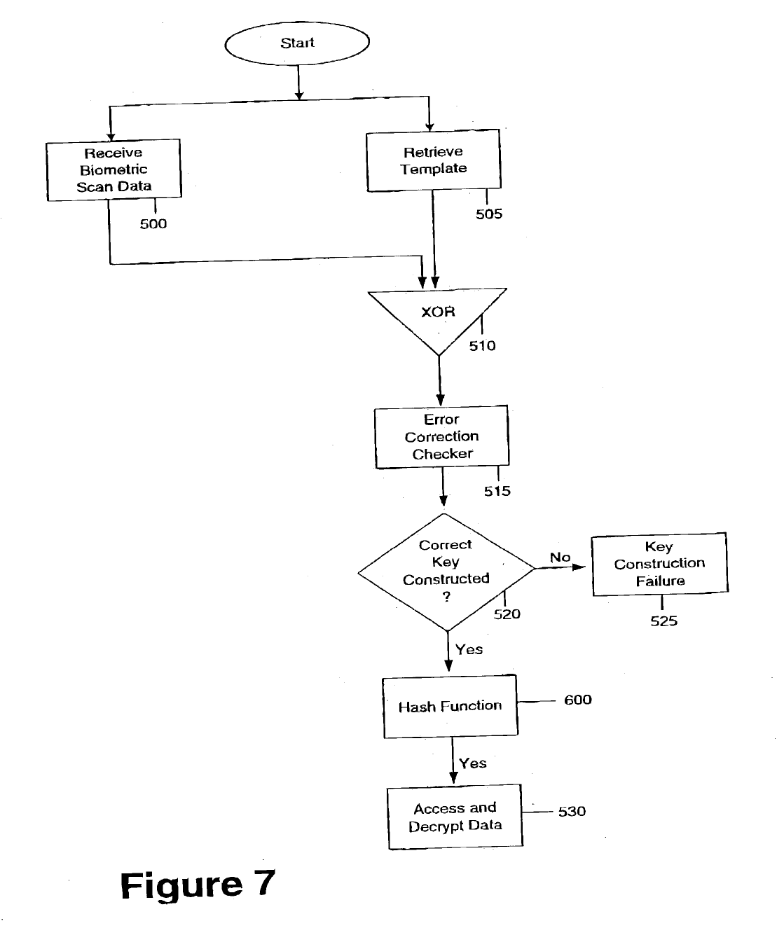

Referring now to FIGS. 3(b) and 7 the retrieval phase of this alternate embodiment will now be described. The biometric scan data 33 generated by the biometric scanner 32 is combined by the reversible operation 38 with the template 40. Again the reversible operation must be the same reversible operation used to create the template in FIG. 3(a). The results of the reversible operation 38 are passed through an error correction code checker 42 in step 515 and if the correct random cryptographic key is reconstructed as determined in step 520, the data stream is passed through the same hash function 70 used in connection with encrypting the data in FIG. 3(a) in step 600. The data is then released and/or decrypted in step 530. In another alternate embodiment of the present invention, the result from the hash function could be used as a key for a digital signature scheme for the user when sending information to other users either on the system or outside of the system. In a preferred embodiment, an implementation of the US Digital Signature Standard (DSS, NIST FIPS 186-2) is used.

Passing the cryptographic key through a hash function before use in the securing, encryption and decryption processes is advantageous because any single uncorrected error in the scan will, with high probability, change a great deal of the random key data. This makes it highly unlikely that an unauthorized user will generate the correct key. Additionally, using a hash function will make it very hard for such a user to search for similar keys if they expect the difference between their scan and the real user's scan to be small.

In another embodiment of the present invention, the fact that the random key is likely to be much shorter than the biometric data is used to perform a key expansion. The random key can be expanded into a set of parts. In this embodiment, a number of key sized chunks of random data are derived so the total is as long as the biometric scan. Exclusive OR operations are then performed on the random data chunks to make the key. The total size of the bits of random data in such case is long, but the resulting key is short. This process performs essentially the same function as the hash function but may be easier to compute. This set of parts can then have the ECC added and used as described above. When the user returns to recreate the key all of the data mixed with the biometric scan data must be close enough to have only correctable errors. In other words, the hamming distance for the scan must have sufficiently few differences from the stored value that all the correct bits for all the chunks can be retrieved. This makes the system more resilient when used with biometric scan data that might have some similarities between different users.

The present invention provides a system and a method to secure data on any computing device, not just trusted computing devices. In one embodiment of the present invention the apparatus and method could be used to secure and, if appropriate, encrypt and decrypt, files on a laptop computer fitted with a biometric scanning device.

While the foregoing invention has been described with reference to its preferred embodiments, various alterations or modifications will occur to those skilled in the art. All such alterations and modifications are intended to fall within the scope of the appended claims.

What is claimed is:

1. A method for generating security information using biometric information, said method comprising the steps of:
receiving scan data relating to a person securing data;
generating a random cryptographic key;
performing a reversible operation on said biometric scan data and said random key to create a template;
storing said template;

2. The method for generating security information using biometric information of claim 1 further comprising the step of adding an error correction code to said random cryptographic key.

3. The method for generating security information using biometric information of claim 2 further comprising the step of adding bits to said biometric scan data for padding purposes.

4. The method for generating security information using biometric information of claim 1 wherein said reversible operation performed on said random cryptographic key and said biometric scan data is an exclusive OR operation.

5. The method for generating security information using biometric information of claim 1 further comprising the step of passing said random cryptographic key through a hash function to produce a hashed random cryptographic key for encrypting data to be secured through the use of said hashed random cryptographic key.

6. A method of retrieving a random cryptographic key originally generated using biometric information, said method comprising the steps of:
receiving biometric scan data relating to a person seeking access to the secured data;
combining, through a reversible operation, said biometric information with a stored template, to derive said random cryptographic key.

7. The method of retrieving a random cryptographic key of claim 6 further comprising the step of passing said derived random cryptographic key through an error correction code checker, wherein said random cryptographic key includes an error correction code.

8. The method of retrieving a random cryptographic key of claim 6 wherein said reversible operation is an exclusive OR operation.

9. The method of retrieving a random cryptographic key of claim 7 wherein said derived cryptographic key is passed through a hash function after it is verified by said error correction code checker.

10. A method securing and unsecuring user data using a biometric cryptographic key, said method comprising the steps of:
receiving a first biometric scan data set relating to a person securing user data;
generating a random cryptographic key;
performing a reversible operation on said biometric scan data and random cryptographic key to create a template;
storing said template;
securing the user data through use of said random cryptographic key;
receiving a second biometric scan data set from a person desiring to retrieve the secured user data;
performing said reversible operation on said template and second biometric scan data set to derive a key;
using said derived key to retrieve said secured user data.

11. The method of securing and unsecuring data of claim 10 further comprising the step of adding an error correction code to said random cryptographic key prior to performing said reversible operation that results in the creation of a template.

12. The method of securing and unsecuring data of claim 10 further comprising the step of adding bits to said random cryptographic key prior to performing said reversible operation that results in the creation of a template in order to make the bit length of the random cryptographic key equal to the bit length of the first biometric scan data set.

13. The method of securing and unsecuring data of claim 10 wherein said reversible operation is an exclusive OR operation.

14. The method of securing and unsecuring data of claim 10 wherein said random cryptographic key is passed through a hash function before it is used to secure said user data.

15. The method of securing and unsecuring data of claim 12 further comprising the step of stripping said added bits from said derived key prior to using said derived key to retrieve said secured user data.

16. A method for securing user data using a random cryptographic key, said method comprising the steps of:
receiving a first biometric scan data set relating to a person securing user data;
generating a random cryptographic key;
performing a reversible operation on said biometric scan data and random key to create a template;
storing said template;
securing the user data through use of said random cryptographic key.

17. The method for securing user data using a random cryptographic key of claim 16 further comprising the step of adding an error correction code to said random key prior to performing said reversible operation that results in the creation of said template.

18. The method for securing user data using a random cryptographic key of claim 16 further comprising the step of adding bits to said random key prior to performing said reversible operation that results in the creation of said template in order to make the bit length of the random cryptographic key equal to the bit length of the first biometric scan data set.

19. The method for securing user data using a random cryptographic key of claim 16 wherein said reversible operation is an exclusive OR operation.

20. The method for securing user data using a random cryptographic key of claim 16 wherein said random key is passed through a hash function before it is used to secure said user data.

21. A method unsecuring data using a random cryptographic key, said method comprising the steps of:
receiving a biometric scan data set from a person desiring to retrieve the secured user data;
performing a reversible operation on a stored template and said biometric scan data set to derive a key;
using said derived key to retrieve said secured data.

22. The method of unsecuring data of claim 21 wherein said reversible operation is an exclusive OR operation.

23. The method of unsecuring data of claim 21 further comprising the step of stripping bits from said derived key prior to using said derived key to retrieve said secured user data.

24. An apparatus for securing and unsecuring data through the use of a biometric cryptographic key comprising:
a biometric scanner;
a secure data system comprising a processor and a first data store, said processor being programmed to generate a random key and for performing reversible operations on biometric scan data sets and said random key to create a template, said processor also securing said data from access by unintended parties through the use of said random key; and
a second data store for storing said template.
